(19) United States
(12) Patent Application Publication
(10) Pub. No.: US 2026/0320802 A1
(43) Pub. Date: Oct. 15, 2026

(54) INFORMATION PROCESSING

(71) Applicants: Bytedance Technology Ltd., Grand Cayman (KY); Beijing Zitiao Network Technology Co., Ltd., Beijing (CN)

(72) Inventors: Xiangtai Li, Singapore (SG); Tao Zhang, Beijing (CN); Zilong Huang, Singapore (SG); Weixian Lei, Singapore (SG); Jiashi Feng, Singapore (SG)

(21) Appl. No.: 19/640,652

(22) Filed: Apr. 7, 2026

(30) Foreign Application Priority Data
Apr. 9, 2025 (CN) 202510442519.3

(51) Int. Cl. G06T 7/11; G06T 3/40

(52) U.S. Cl. CPC G06T 7/11; G06T 3/40; G06T 2207/20081

(57) ABSTRACT

According to the embodiments of the present disclosure, a method, an apparatus, a device, and a storage medium for information processing are provided. The method includes: receiving a processing request associated with media content; obtaining, in response to the processing request indicating to segment an object in the media content, a segmentation feature unit output by a model based on the media content and the processing request; and generating a segmentation mask for the object based on the segmentation feature unit and a set of visual feature units associated with the media content. Based on this method, the embodiments of the disclosure may use a single model to implement an image segmentation operation, which greatly reduces the complexity of the overall architecture of image segmentation.

### CROSS-REFERENCE

The present application claims priority to Chinese Patent Application No. 202510442519.3, filed on Apr. 9, 2025, and entitled “METHOD, APPARATUS, DEVICE, AND STORAGE MEDIUM FOR INFORMATION PROCESSING”, which is incorporated herein by reference in its entirety.

### FIELD

Example embodiments of the present disclosure generally relate to the field of computers, and in particular, to information processing.

### BACKGROUND

Image segmentation is a key technology in the field of computer vision. A core objective of the image segmentation is to divide a digital image into a plurality of regions or objects with specific meanings, so that pixels in each region have consistency in a certain characteristic. However, an overall architecture applied to perform the image segmentation is too complex. Therefore, a more simple and effective image segmentation method is required.

### SUMMARY

In a first aspect of the present disclosure, a method for information processing is provided. The method includes: receiving a processing request associated with media content; obtaining, in response to the processing request indicating segmenting an object in the media content, a segmentation feature unit output by a model based on the media content and the processing request; and generating a segmentation mask for the object based on the segmentation feature unit and a set of visual feature units associated with the media content.

In a second aspect of the present disclosure, an apparatus for information processing is provided. The apparatus includes: a receiving module configured to receive a processing request associated with media content; an obtaining module configured to obtain, in response to the processing request indicating segmenting an object in the media content, a segmentation feature unit output by a model based on the media content and the processing request; and a generating module configured to generate a segmentation mask for the object based on the segmentation feature unit and a set of visual feature units associated with the media content.

In a third aspect of the present disclosure, an electronic device is provided. The device includes at least one processor; and at least one memory coupled to the at least one processor and storing instructions for execution by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, the computer program being executable by a processor to implement the method of the first aspect.

In a fifth aspect of the present disclosure, a computer program product is provided. The computer program product includes computer-executable instructions that, when executed by a processor, implement the method according to the first aspect of the present disclosure.

It should be understood that content described in this section is neither intended to define key or essential features of the embodiments of the present disclosure, nor is it intended to limit the scope of the present disclosure. Other features of the present disclosure will be readily understood through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar embedded elements.

FIG. 1 is a schematic diagram of an example environment in which the embodiments of the present disclosure may be implemented;

FIG. 2 is a flowchart of a process of information processing according to some embodiments of the present disclosure;

FIG. 3 is a first schematic diagram of segmentation by applying a model according to some embodiments of the present disclosure;

FIG. 4 is a second schematic diagram of segmentation by applying a model according to some embodiments of the present disclosure;

FIG. 5 is a schematic diagram of segmentation by applying a baseline model according to some embodiments of the present disclosure;

FIG. 6 is a schematic structural block diagram of an apparatus for information processing according to some embodiments of the present disclosure; and

FIG. 7 is a block diagram of an electronic device capable of implementing a plurality of embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for more thorough and complete understanding of the present disclosure. It should be understood that the drawings and embodiments of the present disclosure are only used for illustrative purposes, and are not used to limit the protection scope of the present disclosure.

It should be noted that the title of any section/subsection provided herein is not restrictive. Various embodiments are described throughout this specification, and any type of embodiments may be included under any section/subsection. In addition, the embodiments described in any section/subsection may be combined with any other embodiments described in the same section/subsection and/or different section/subsection in any manner.

In the description of the embodiments of the present disclosure, the term “include/comprise” and similar terms should be understood as open-ended inclusions, that is, “include/comprise but not limited to”. The term “based on” should be understood as “based at least partially on”. The term “an embodiment” or “the embodiment” should be understood as “at least one embodiment”. The term “some embodiments” should be understood as “at least some embodiments”. Other explicit and implicit definitions may also be included below. The terms “first” and “second” may refer to different or same objects. Other explicit and implicit definitions may also be included below.

The embodiments of the present disclosure may involve user data, data acquisition and/or data use, and the like. These aspects all comply with corresponding laws, regulations, and related provisions. In the embodiments of the present disclosure, all data collection, acquisition, processing, machining, forwarding, and use are performed on the premise that the user is aware and confirms. Correspondingly, when implementing the embodiments of the present disclosure, the user should be informed of the data or the type of data, the scope of use, the use scenario, etc. that may be involved and the authorization of the user should be obtained in an appropriate manner in accordance with relevant laws and regulations. The specific manner of informing and/or authorizing may be changed according to the actual situation and application scenarios, and the scope of the present disclosure is not limited in this regard.

If the solutions in this specification and the embodiments involve personal information processing, the processing will be performed on the premise that there is a legal basis (for example, the consent of the personal data subject is obtained, or it is necessary to perform a contract, etc.), and the processing will only be performed within the scope of regulations or agreements. If the user refuses to process personal data other than the necessary data required for the basic functions, it will not affect the user's use of the basic functions.

A traditional image segmentation method is to attach a segmentation model after an output of a language model, or embed a language model into a segmentation process. The overall structure of these methods is too complex, and special components such as a vision-language fusion module, an encoder, and a decoder are required. In addition, the final performance often depends largely on the language model or the segmentation model. Due to the limitation of a single submodule, the result is not ideal.

Embodiments of the present disclosure proposes a solution for information processing. According to the solution, a processing request associated with media content is received; in response to the processing request indicating to segment an object in the media content, a segmentation feature unit output by a model based on the media content and the processing request is obtained; and a segmentation mask for the object is generated based on the segmentation feature unit and a set of visual feature units associated with the media content.

Based on this method, the embodiments of the present disclosure may use a single model to implement an image segmentation operation, which greatly reduces the complexity of the overall architecture of image segmentation. Furthermore, by integrating a learnable upsampling module, the segmentation capability of the model is fully exploited, thereby outputting a more accurate result.

### Example Environment

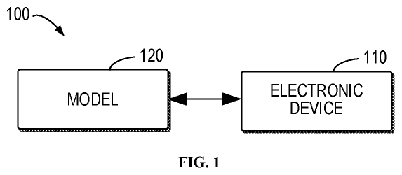

FIG. 1 is a schematic diagram of an example environment 100 in which the embodiments of the present disclosure may be implemented. As shown in FIG. 1, the example environment 100 may include an electronic device 110.

In some embodiments, the electronic device 110 may receive a processing request associated with media content; obtain, in response to the processing request indicating segmenting an object in the media content, a segmentation feature unit output by a model 120 based on the media content and the processing request; and generate a segmentation mask for the object based on the segmentation feature unit and a set of visual feature units associated with the media content. The model 120 may be deployed on the electronic device 110, or may be deployed on another device, which will not be repeated here.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the accessories and peripherals of these devices or any combination thereof. In some embodiments, the electronic device 110 may also support any type of interface for a target user (such as a “wearable” circuit, etc.).

The electronic device 110 may also be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The electronic device 110 may include, for example, a computing system/server, such as a mainframe, an edge computing node, a computing device in a cloud environment, and so on.

It should be understood that the structure and function of each embedded element in the environment 100 are described for illustrative purposes only, and do not imply any limitation on the scope of the present disclosure.

Some example embodiments of the present disclosure are described below with continued reference to the drawings.

### Example Process

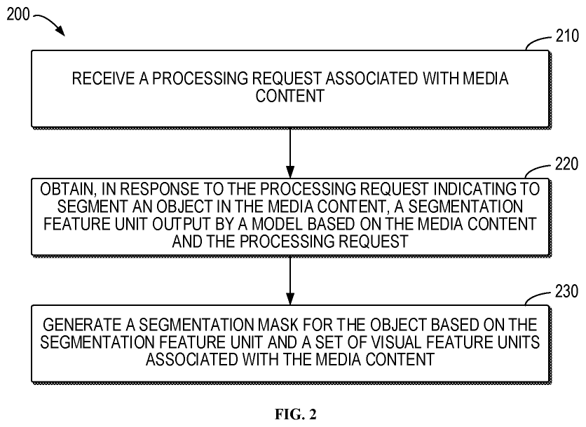

FIG. 2 is a flowchart of a process 200 of information processing according to some embodiments of the present disclosure. The process 200 may be implemented at the electronic device 110. The process 200 is described below with reference to FIG. 1.

At block 210, the electronic device 110 may receive a processing request associated with media content.

In some embodiments, the media content may include presentation forms such as images and videos. The processing request is configured to indicate segmenting an object in the media content. For example, the media content may be an image, and the received processing request may include “please segment the cat in the picture”, then the processing request indicates segmenting the cat in the image.

At block 220, the electronic device 110 may obtain, in response to the processing request indicating segmenting an object in the media content, a segmentation feature unit output by a model based on the media content and the processing request.

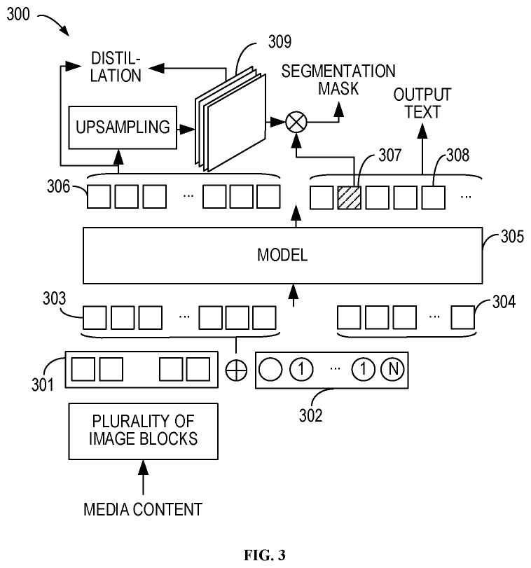

In some embodiments, the segmentation feature unit is generated by the model based on a predefined mark, and is used to control a behavior of the model, process a specific task, or mark a text structure. The segmentation feature unit enhances an understanding capability of the model to input content and a control capability of the model to output content by explicitly mark structural or functional information. For example, referring to FIG. 3, the electronic device 110 may obtain, in response to the processing request indicating to segment the object in the media content, a segmentation feature unit 307 output by a model 305 based on the media content and the processing request.

At block 230, the electronic device 110 may generate a segmentation mask for the object based on the segmentation feature unit and a set of visual feature units associated with the media content.

In some embodiments, referring to FIG. 3, the electronic device 110 may determine a second set of visual feature units 303 to be input to the model based on the media content, and then obtain a first set of visual feature units 306 generated by the model based on the second set of visual feature units 303. For example, if the media content is an image, a second set of visual feature units 303 corresponding to the image may be determined, and the second set of visual feature units 303 may be input to the model to obtain the first set of visual feature units 306 output by the model.

In some embodiments, referring to FIG. 3, the electronic device 110 may divide the media content into a plurality of image blocks, and then construct the second set of visual feature units 303 based on a plurality of first embedding representations 301 corresponding to the plurality of image blocks. For example, if the media content is an image, the image may be divided into a plurality of 32×32 image blocks, then the plurality of first embedding representations 301 are determined based on the plurality of image blocks, and then the second set of visual feature units 303 is constructed based on the plurality of first embedding representations 301.

In some embodiments, referring to FIG. 3, when performing an image segmentation operation only by relying on the plurality of image blocks, the model cannot obtain more detailed feature information. Therefore, a visual prompt information injection mechanism may be used to enable the model to better understand and apply visual prompt information, thereby improving the segmentation accuracy of the model. Then, the electronic device 110 may obtain visual prompt information associated with the media content, where the visual prompt information indicates a region of a reference object in the media content. Then, a plurality of second embedding representations 302 are constructed based on the visual prompt information. Then, the second set of visual feature units 303 is constructed based on the plurality of first embedding representations 301 and the plurality of second embedding representations 302.

The visual prompt information refers to a technology configured to guide and optimize the performance of the model in the field of computer vision. By adding specific visual prompt information to the model input, the visual model may be helped to better understand and process tasks. In the embodiments of the present disclosure, the visual prompt information may be configured to indicate the region of the reference object in the media content. For example, if the media content is an image, and the image includes a cat and a ball, visual prompt information corresponding to the cat may be represented by <vp1>, and visual prompt information corresponding to the ball may be represented by <vp2>.

In addition, the visual prompt information may have various expression forms, such as a dot map, a bounding box, a mask map, and the like. The visual prompt information may also be determined based on a user's interaction operation on the media content. For example, the user may determine the visual prompt information by clicking a predetermined position in the media content or adding a predetermined mark in the media content.

The second embedding representation 302 is configured to fill the feature corresponding to the visual prompt information into the corresponding image block, and the second embedding representation 302 includes a plurality of second elements. For example, referring to FIG. 3, the second embedding representation 302 includes a plurality of second elements marked as null, 1, and N, the second element marked as 1 corresponds to the visual prompt information <vp1>, the second element marked as N corresponds to the visual prompt information <vpN>, and the second element marked as null does not have corresponding visual prompt information.

In some embodiments, the first embedding representation 301 includes a plurality of first elements, and there is a positional mapping relationship between the plurality of first elements and the plurality of second elements. Then, the second set of visual feature units 303 injected with the visual prompt information may be obtained through a fusion operation of the first embedding representation 301 and the second embedding representation 302. This approach of early fusion of the first embedding representation 301 and the second embedding representation 302 before being input to the model helps the model to more effectively understand the visual prompt information.

For example, if the media content is an image, and the image includes a cat and a ball, the visual prompt information corresponding to the cat is represented by <vp1>, and the visual prompt information corresponding to the ball is represented by <vp2>. The second embedding representation 302 includes a second element marked as 1 and a second element marked as 2, the second element marked as 1 corresponds to the visual prompt information <vp1>, and the second element marked as 2 corresponds to the visual prompt information <vp2>. Then, through the fusion of the first embedding representation 301 and the second embedding representation 302, the first element corresponding to the second element marked as 1 is determined, and the feature of the cat corresponding to the visual prompt information <vp1> is filled in; the first element corresponding to the second element marked as 2 is determined, and the feature of the ball corresponding to the visual prompt information <vp2> is filled in.

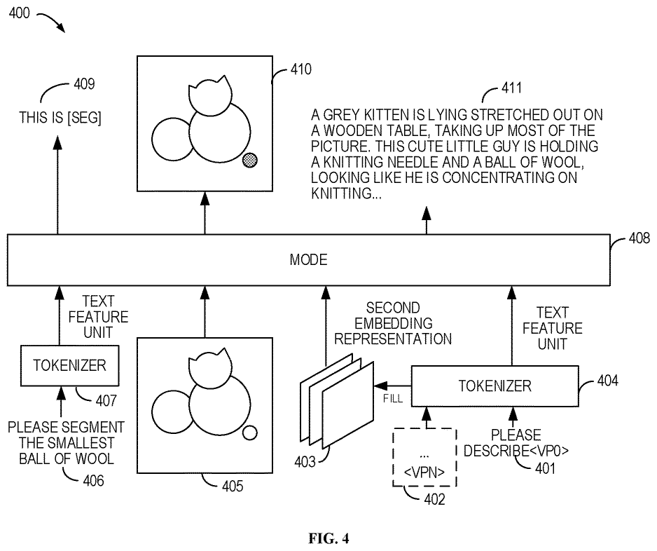

In some embodiments, referring to FIG. 4, a plurality of visual prompt information {VPᵢ|i∈[1,N]} may be predetermined, these visual prompt information 402 are added to a predetermined vocabulary corresponding to the model, and visual prompt information 403 in a mask form is constructed according to the predetermined visual prompt information. Then, the text content 401 included in the processing request is input to a tokenizer 404, so as to use the text embedding representation VP^{t}∈R^{N×C} corresponding to the text content 401 to fill the visual prompt information

$${M}^{vp} ∈ {R}^{N \times \frac{H}{P} \times \frac{W}{P}}$$

in the mask form, and then construct the feature unit

$$VP ∈ {R}^{\frac{HW}{{P}^{2}} \times C}$$

corresponding to the visual prompt information. That is, before the model processing, the visual feature unit V has already been added with the feature unit VP. N represents the number of visual feature units, C represents the channel size, H and W represent the height and width of the media content, and P represents the size of the image block.

In some embodiments, the text content 401 may include visual prompt information. For example, the text content 401 may be “please segment <vp1> in the picture”. In this way, the model may use the visual prompt information {VPᵢ|i∈[1,N]} in the text content 401 to accurately identify the object in the media content, thereby achieving a better segmentation effect.

In some embodiments, referring to FIG. 3, the electronic device 110 may construct, in response to a target block among the plurality of image blocks being located in the region, the second embedding representation 302 corresponding to the target block based on a target feature unit corresponding to the visual prompt information. The target feature unit indicates a feature corresponding to the visual prompt information. For example, if the media content is an image, and the image includes a cat, after the media content is divided into a plurality of image blocks, some image blocks may fall into the region including the cat, and some image blocks may fall into the region not including the cat. If the visual prompt information corresponds to the region where the cat is located in the image, the second embedding representation 302 corresponding to the target block may be constructed according to the target feature unit corresponding to the visual prompt information, and the second embedding representation 302 is configured to fill the feature corresponding to the cat into the image block where the cat is located.

In some embodiments, the electronic device 110 may compare, in response to the target block being also located in a second region corresponding to second visual prompt information, a first priority of first visual prompt information with a second priority of the second visual prompt information; and in response to the first priority being higher than the second priority, construct the second embedding representation 302 corresponding to the target block based on the target feature unit corresponding to the visual prompt information.

For example, if the media content is an image, and the image describes a scene of a cat playing with a ball, after the media content is divided into a plurality of image blocks, there may be a target block that falls into both the region where the cat is located and the region where the ball is located. Then, the first priority of first prompt information corresponding to the cat may be compared with the second priority of second prompt information corresponding to the ball. If the first priority is higher than the second priority, it may be determined that the target block corresponds to the region where the cat is located, and the second embedding representation 302 corresponding to the target block is constructed according to the target feature unit corresponding to the visual prompt information. The second embedding representation 302 is configured to fill the feature corresponding to the cat into the target patch where the cat is located.

In some embodiments, the first priority or the second priority is determined based on a first size of the first region or a second size of the second region. For example, if the target block falls into both the region where the cat is located and the region where the ball is located, the first size of the region where the cat is located and the second size of the region where the ball is located may be determined, and the first size is compared with the second size. The prompt information corresponding to the region with a smaller size is given a higher priority. If the second size is smaller than the first size, it may be determined that the target block corresponds to the region where the ball is located, and the second embedding representation 302 corresponding to the target block is constructed based on the target feature unit corresponding to the visual prompt information. The second embedding representation 302 is configured to fill the feature corresponding to the ball into the target patch where the ball is located.

In some embodiments, referring to FIG. 3, the electronic device 110 may upsample a set of visual feature units 306 by using an upsampling unit to determine a visual feature 309 corresponding to a size of the media content. Then, the segmentation mask for the object is generated based on the visual feature and the segmentation feature unit. For example, the electronic device 110 may upsample a set of low-resolution visual feature units

$${F}_{l} ∈ {R}^{\frac{H}{S} \times \frac{W}{S} \times C}$$

by using the upsampling unit, where S represents the sampling step size, to determine the high-resolution visual feature

$${F}_{h} ∈ {R}^{\frac{H}{4} \times \frac{W}{4} \times C}$$

corresponding to the size of the media content. Then, the segmentation mask for the object is generated based on the visual feature and the segmentation feature unit. That is to say, through the upsampling unit, the resolution of the visual feature unit

$${F}_{l} ∈ {R}^{\frac{H}{S} \times \frac{W}{S} \times C}$$

may be increased to four times that of the original media content, which may help the single model fully unleash its capabilities in graphics segmentation.

In some embodiments, a learnable upsampling unit may be applied to generate the high-resolution visual feature

$${F}_{h} ∈ {R}^{\frac{H}{4} \times \frac{W}{4} \times C} .$$

The upsampling unit may efficiently increase the resolution of the visual feature and optimize the feature expression, which is very important for pixel-level localization. For example, the upsampling unit may include a plurality of upsampling sub-units, and each upsampling sub-unit includes a transposed two-dimensional convolution followed by a depthwise separable convolution. The transposed two-dimensional convolution is a convolution operation that is the inverse operation of the standard two-dimensional convolution and is commonly used for upsampling and transposing feature maps. The depthwise separable convolution is a convolution operation that includes two steps: a depthwise convolution and a pointwise convolution, which may reduce the amount of computation and the number of parameters while maintaining the expressiveness and performance of the model.

In some embodiments, the model may be trained through the distillation loss to improve the fine-grained feature extraction capability of the model, that is, the upsampling unit is trained based on the following process: referring to FIG. 3, a set of training visual units 306 may be processed by using the upsampling unit to generate a first visual feature 309 corresponding to the training media content. Then, the first segmentation feature of the training media content is determined by using a pre-trained first segmentation model based on the first visual feature 309. Then, a second segmentation feature of the training media content is determined by using a pre-trained second segmentation model based on the set of training visual units 306. Then, the upsampling unit is trained based on the comparison between the first segmentation feature and the second segmentation feature.

The distillation loss is a loss function in knowledge distillation, which is configured to measure the difference between the output of the student model and the output of the expert model, thereby migrating the knowledge of the expert model to the student model. The core idea is to make the student model mimic the behavior of the expert model by matching the output distribution of the two models.

In some embodiments, the distillation loss L_{distill} may be constructed by comparing the first segmentation feature with the second segmentation feature, and the loss function may be constructed by the model prediction loss Lₙₜₚ, the segmentation loss L_{seg}, and the distillation loss L_{distill}.L_{ce} is the cross-entropy loss, and the loss function formula may be as follows:

L=Lₙₜₚ+L_{seg}+αL_{distill}

L_{seg}=λL_{ce}+βL_{seg}

α is set to 0.5, λ is set to 2.0, and β is set to 0.5. The above parameters may also be adjusted according to actual applications.

In some embodiments, other suitable segmentation models may also be applied to the model training process, which is not limited herein. In this way, expertise in the field of segmentation may be introduced through the expert model. This knowledge distillation strategy only negligibly extends the training time of the network model, but may ensure the optimization of object details and the improvement of segmentation quality without impairing the visual question answering ability of the network model.

In some embodiments, the processing request may include text content, and the text content includes visual prompt information. For example, referring to FIG. 3, the media content may be divided into a plurality of image blocks, and the first embedding representations 301 corresponding to the plurality of image blocks are determined. The second embedding representation 302 is determined based on the visual prompt information, and the text embedding representation 304 is determined based on the text content. Then, the first embedding representation 301 and the second embedding representation 302 are fused to obtain the second set of visual feature units 303. The second set of visual feature units 303 and the text embedding representation 304 are input to the model 305 to obtain the first set of visual feature units 306 and output text 308, and the output text 308 includes the segmentation feature unit 307. Then, the first set of visual feature units 306 are upsampled to obtain the visual feature 309. Then, the visual feature 309 is multiplied point-wise by the segmentation feature unit 307 to obtain the segmentation mask for the object.

For another example, referring to FIG. 4, the media content is 405, the processing request includes “please describe <vp0>”, and the model 408 may correspondingly output the content in the box 411: “A grey kitten is lying stretched out on a wooden table, taking up most of the picture. This cute little guy is holding a knitting needle and a ball of wool, looking like he is concentrating on knitting . . . .” For another example, the processing request includes the content of 406 in FIG. 4: “please segment the smallest ball of wool”, and after passing through the tokenizer 407, the model 408 may correspondingly output the image 410, and the part of the ball of wool in the image 410 is marked.

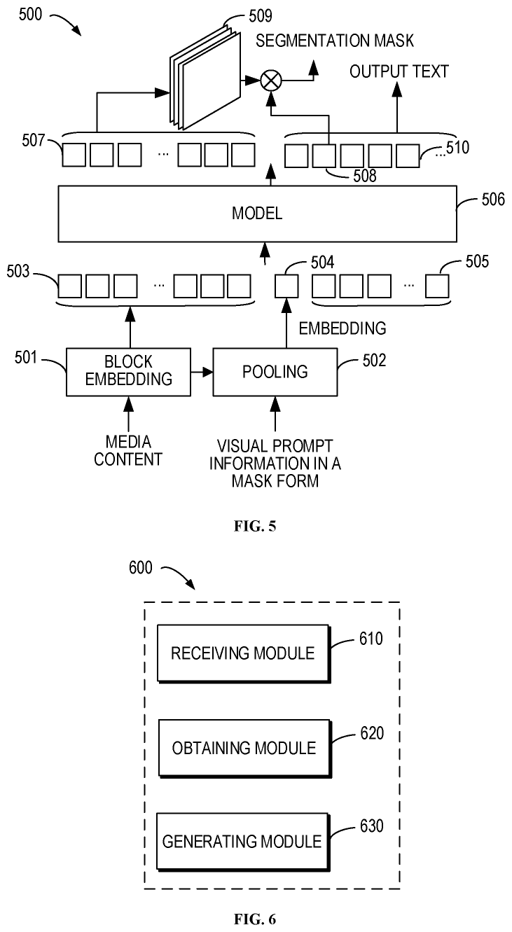

In some embodiments, a baseline model shown in FIG. 5 may also be constructed, and the baseline model may be used as a benchmark or reference point of performance to help researchers evaluate whether the improvement of a new model is effective. For example, a pooling method may be applied to determine a representation form O∈R^{M×C} of the object based on a visual feature unit 503,

$$P ∈ {R}^{\frac{H}{P} \times \frac{W}{P} \times C}$$

may be applied to represent the visual feature unit 503, M represents the number of pieces of visual prompt information, and P represents the size of the image block. Then, the visual feature unit 503, an embedding representation 504 corresponding to the visual prompt information, and a text embedding representation 505 are input to a model 506 to obtain a visual feature unit 507 and output text 510, and the output text 510 includes a segmentation feature unit 508.

Next, the visual feature unit 507 may be reshaped into a visual feature 509 corresponding to the media content, V∈R^{N×C} may be applied to represent the visual feature unit 507, and

$${F}_{l} ∈ {R}^{\frac{H}{S} \times \frac{W}{S} \times C}$$

may be applied to represent the visual feature 509. Then, the visual feature 509 is cross-multiplied by the segmentation feature unit 508 output by the model to generate a segmentation mask

$$M ∈ {R}^{K \times \frac{H}{S} \times \frac{W}{S}} ,$$

the segmentation feature unit 508 may be represented by Q∈R^{N×C}, and K represents the number of segmentation feature units.

The embodiments of the present disclosure may use a single model to implement the image segmentation operation, which greatly reduces the complexity of the overall architecture of the image segmentation. By introducing a learnable upsampling model, the low-resolution visual feature unit may be optimized in the high-resolution visual feature. Then, through the visual prompt injection mechanism, the model may be enabled to better understand and apply the visual prompt information, thereby improving the segmentation accuracy of the model. Moreover, through the distillation loss, expertise in the field of segmentation is applied to improve the quality of the final generated segmentation mask.

### Example Apparatus and Device

The embodiments of the present disclosure further provide corresponding apparatuses for implementing the above methods or processes. FIG. 6 shows a schematic structural block diagram of an apparatus 600 for information processing according to some embodiments of the present disclosure. The apparatus 600 may be implemented as or included in the electronic device 110 as discussed above. Each module/component in the apparatus 600 may be implemented by hardware, software, firmware, or any combination thereof.

As shown in FIG. 6, the apparatus 600 includes a receiving module 610 configured to receive a processing request associated with media content; an obtaining module 620 configured to obtain, in response to the processing request indicating segmenting an object in the media content, a segmentation feature unit output by a model based on the media content and the processing request; and a generating module 630 configured to generate a segmentation mask for the object based on the segmentation feature unit and a set of visual feature units associated with the media content.

In some embodiments, the generating module 630 is configured to upsample the set of visual feature units by using an upsampling unit to determine a visual feature corresponding to a size of the media content; and generate the segmentation mask for the object based on the visual feature and the segmentation feature unit.

In some embodiments, the upsampling unit is trained based on the following process: processing a set of training visual units by using the upsampling unit to generate a first visual feature corresponding to training media content; determining, based on the first visual feature, a first segmentation feature of the training media content by using a pre-trained first segmentation model; determining based on the set of training visual units, a second segmentation feature of the training media content by using a pre-trained second segmentation model; and training the upsampling unit based on a comparison between the first segmentation feature and the second segmentation feature.

In some embodiments, the set of visual feature units is a first set of visual feature units, and the apparatus 600 may further include a determining module configured to determine, based on the media content, a second set of visual feature units to be input to the model; and a feature unit obtaining module configured to obtain the first set of visual feature units generated by the model based on the second set of visual feature units.

In some embodiments, the determining module includes a dividing sub-module configured to divide the media content into a plurality of image blocks; and a first constructing sub-module configured to construct the second set of visual feature units based on a plurality of first embedding representations corresponding to the plurality of image blocks.

In some embodiments, the first constructing sub-module includes an obtaining module configured to obtain visual prompt information associated with the media content, the visual prompt information indicating a region of a reference object in the media content; a second constructing sub-module configured to construct a plurality of second embedding representations based on the visual prompt information; and a third constructing sub-module configured to construct the second set of visual feature units based on the plurality of first embedding representations and the plurality of second embedding representations.

In some embodiments, the second constructing sub-module is configured to construct, in response to a target block among the plurality of image blocks being located in the region, a second embedding representation corresponding to the target block based on a target feature unit corresponding to the visual prompt information.

In some embodiments, the second constructing sub-module is further configured to compare, in response to the target block being also located in a second region corresponding to second visual prompt information, a first priority of first visual prompt information with a second priority of the second visual prompt information; and construct, in response to the first priority being higher than the second priority, the second embedding representation corresponding to the target block based on the target feature unit corresponding to the visual prompt information.

In some embodiments, the first priority or the second priority is determined based on a first size of the first region or a second size of the second region.

The units included in the apparatus 600 may be implemented in various ways, including software, hardware, firmware, or any combination thereof. In some embodiments, one or more units may be implemented using software and/or firmware, for example machine-executable instructions stored on a storage medium. In addition to machine-executable instructions or as an alternative, some or all units in the apparatus 600 may be implemented at least partially by one or more hardware logic components. As an example, rather than a limitation, example types of hardware logic components that may be used include field programmable gate arrays (FPGAs), application specific integrated circuits (ASICs), application specific standard parts (ASSPs), system on chips (SOCs), complex programmable logic devices (CPLDs), and so on.

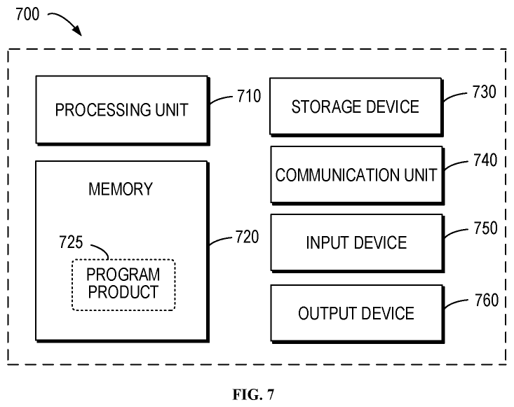

FIG. 7 shows a block diagram of an electronic device 700 in which one or more embodiments of the present disclosure may be implemented. It should be understood that the electronic device 700 shown in FIG. 7 is only illustrative and should not constitute any limitation on the function and scope of the embodiments described herein. The electronic device 700 shown in FIG. 7 may be used to implement the electronic device 110 shown in FIG. 1.

As shown in FIG. 7, the electronic device 700 is in the form of a general electronic device. The components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor, and may execute various processes based on the program stored in the memory 720. In a multi-processor system, a plurality of processing units execute computer-executable instructions in parallel to improve the parallel processing capability of the electronic device 700.

The electronic device 700 typically includes a plurality of computer storage medium. Such medium may be any available medium that is accessible to the electronic device 700, including but not limited to volatile and non-volatile medium, removable and non-removable medium. The memory 720 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 730 may be a removable or non-removable medium, and may include a machine-readable medium such as a flash drive, a disk, or any other medium, which may be used to store data and/or information (such as training data for training) and may be accessed within the electronic device 700.

The electronic device 700 may further include other removable/non-removable, volatile/non-volatile memory medium. Although not shown in FIG. 7, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 implements communication with other electronic devices through the communication medium. In addition, the functions of the components of the electronic device 700 may be implemented by a single computing cluster or a plurality of computing machines, which may communicate through communication connections. Therefore, the electronic device 700 may use a logical connection with one or more other servers, a network personal computer (PC), or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may also communicate with one or more external devices (not shown) through the communication unit 740 as needed, the external devices such as the storage device, the display device, etc., communicate with one or more devices that enable the user to interact with the electronic device 700, or communicate with any devices (such as a network card, a modem, etc.) that enable the electronic device 700 to communicate with one or more other electronic devices. Such communication may be performed via input/output (I/O) interfaces (not shown).

According to an example implementation of the present disclosure, a computer-readable storage medium is provided, which has computer-executable instructions stored thereon, where the computer-executable instructions are executed by a processor to implement the method described above. According to an example implementation of the present disclosure, a computer program product is further provided, the computer program product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowchart and/or block diagram, may be implemented by computer-readable program instructions.

These computer-readable program instructions may be provided to the processing unit of a general-purpose computer, a special-purpose computer, or other programmable information processing apparatus to produce a machine, such that these instructions, when executed by the processing unit of the computer or other programmable information processing apparatus, produce an apparatus for implementing a function/act specified in one or more blocks of the flowchart and/or block diagram. These computer-readable program instructions may also be stored in a computer-readable storage medium, these instructions cause the computer, the programmable information processing apparatus, and/or other devices to work in a specific manner, and thus, the computer-readable medium storing the instructions includes a manufactured product, which includes instructions for implementing various aspects of the function/act specified in one or more blocks of the flowchart and/or block diagram.

The computer-readable program instructions may be loaded onto a computer, another programmable information processing apparatus, or another device, such that a series of operation steps are performed on the computer, the another programmable information processing apparatus, or the another device to produce a computer-implemented process, thereby causing the instructions executed on the computer, the another programmable information processing apparatus, or the another device to implement the function/act specified in one or more blocks of the flowchart and/or block diagram.

The flowchart and block diagram in the drawings show the possibly implemented architectures, functions, and operations of the system, the method, and the computer program product according to a plurality of implementations of the present disclosure. In this regard, each block in the flowchart or block diagram may represent a module, a program segment, or a part of instructions, and the module, the program segment, or the part of instructions contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a special-purpose hardware-based system that executes specified functions or acts, or may be implemented by a combination of special-purpose hardware and computer instructions.

The implementations of the present disclosure have been described above, and the above description is illustrative, non-exhaustive, and not limited to the disclosed implementations. Without departing from the scope and spirit of the illustrated implementations, many modifications and changes will be apparent to those of ordinary skill in the art. The selection of terms used herein is intended to best explain the principles, practical applications, or improvements to the technology in the market of the implementations, or to enable other those of ordinary skill in the art to understand the implementations disclosed herein.

1. A method for information processing, comprising:
receiving a processing request associated with media content;
obtaining, in response to the processing request indicating segmenting an object in the media content, a segmentation feature unit output by a model based on the media content and the processing request; and
generating a segmentation mask for the object based on the segmentation feature unit and a set of visual feature units associated with the media content.

2. The method of claim 1, wherein generating the segmentation mask for the object based on the segmentation feature unit and the set of visual feature units associated with the media content comprises:
upsampling the set of visual feature units by using an upsampling unit to determine a visual feature corresponding to a size of the media content; and
generating the segmentation mask for the object based on the visual feature and the segmentation feature unit.

3. The method of claim 2, wherein the upsampling unit is trained based on a process of:
processing a set of training visual units by using the upsampling unit to generate a first visual feature corresponding to training media content;
determining, based on the first visual feature, a first segmentation feature of the training media content by using a pre-trained first segmentation model;
determining, based on the set of training visual units, a second segmentation feature of the training media content by using a pre-trained second segmentation model; and
training the upsampling unit based on a comparison between the first segmentation feature and the second segmentation feature.

4. The method of claim 1, wherein the set of visual feature units is a first set of visual feature units, and the method further comprises:
determining, based on the media content, a second set of visual feature units to be input to the model; and
obtaining the first set of visual feature units generated by the model based on the second set of visual feature units.

5. The method of claim 4, wherein determining, based on the media content, the second set of visual feature units to be input to the model comprises:
dividing the media content into a plurality of image blocks; and
constructing the second set of visual feature units based on a plurality of first embedding representations corresponding to the plurality of image blocks.

6. The method of claim 5, wherein constructing the second set of visual feature units based on the plurality of first embedding representations corresponding to the plurality of image blocks comprises:
obtaining visual prompt information associated with the media content, the visual prompt information indicating a region of a reference object in the media content;
constructing a plurality of second embedding representations based on the visual prompt information; and
constructing the second set of visual feature units based on the plurality of first embedding representations and the plurality of second embedding representations.

7. The method of claim 6, wherein constructing the plurality of second embedding representations based on the visual prompt information comprises:
constructing, in response to a block among the plurality of image blocks being located in the region, the second embedding representation corresponding to the block based on a feature unit corresponding to the visual prompt information.

8. The method of claim 7, wherein the visual prompt information is first visual prompt information, the region is a first region, and constructing the second embedding representation corresponding to the block based on the feature unit corresponding to the visual prompt information further comprises:
comparing, in response to the block being also located in a second region corresponding to second visual prompt information, a first priority of the first visual prompt information with a second priority of the second visual prompt information; and
constructing, in response to the first priority being higher than the second priority, the second embedding representation corresponding to the block based on the feature unit corresponding to the visual prompt information.

9. The method of claim 8, wherein the first priority or the second priority is determined based on a first size of the first region or a second size of the second region.

10. An electronic device, comprising:
at least one processor unit; and
at least one memory coupled to the at least one processor and storing instructions for execution by the at least one processor, the instructions, when executed by the at least one processor, causing the electronic device to perform acts comprising:
receiving a processing request associated with media content;
obtaining, in response to the processing request indicating segmenting an object in the media content, a segmentation feature unit output by a model based on the media content and the processing request; and
generating a segmentation mask for the object based on the segmentation feature unit and a set of visual feature units associated with the media content.

11. The electronic device of claim 10, wherein generating the segmentation mask for the object based on the segmentation feature unit and the set of visual feature units associated with the media content comprises:
upsampling the set of visual feature units by using an upsampling unit to determine a visual feature corresponding to a size of the media content; and
generating the segmentation mask for the object based on the visual feature and the segmentation feature unit.

12. The electronic device of claim 11, wherein the upsampling unit is trained based on a process of:
processing a set of training visual units by using the upsampling unit to generate a first visual feature corresponding to training media content;
determining, based on the first visual feature, a first segmentation feature of the training media content by using a pre-trained first segmentation model;
determining, based on the set of training visual units, a second segmentation feature of the training media content by using a pre-trained second segmentation model; and
training the upsampling unit based on a comparison between the first segmentation feature and the second segmentation feature.

13. The electronic device of claim 10, wherein the set of visual feature units is a first set of visual feature units, and the acts further comprises:
determining, based on the media content, a second set of visual feature units to be input to the model; and
obtaining the first set of visual feature units generated by the model based on the second set of visual feature units.

14. The electronic device of claim 13, wherein determining, based on the media content, the second set of visual feature units to be input to the model comprises:
dividing the media content into a plurality of image blocks; and
constructing the second set of visual feature units based on a plurality of first embedding representations corresponding to the plurality of image blocks.

15. The electronic device of claim 14, wherein constructing the second set of visual feature units based on the plurality of first embedding representations corresponding to the plurality of image blocks comprises:
obtaining visual prompt information associated with the media content, the visual prompt information indicating a region of a reference object in the media content;
constructing a plurality of second embedding representations based on the visual prompt information; and
constructing the second set of visual feature units based on the plurality of first embedding representations and the plurality of second embedding representations.

16. The electronic device of claim 15, wherein constructing the plurality of second embedding representations based on the visual prompt information comprises:
constructing, in response to a block among the plurality of image blocks being located in the region, the second embedding representation corresponding to the block based on a feature unit corresponding to the visual prompt information.

17. The electronic device of claim 16, wherein the visual prompt information is first visual prompt information, the region is a first region, and constructing the second embedding representation corresponding to the block based on the feature unit corresponding to the visual prompt information further comprises:
comparing, in response to the block being also located in a second region corresponding to second visual prompt information, a first priority of the first visual prompt information with a second priority of the second visual prompt information; and
constructing, in response to the first priority being higher than the second priority, the second embedding representation corresponding to the block based on the feature unit corresponding to the visual prompt information.

18. The electronic device of claim 17, wherein the first priority or the second priority is determined based on a first size of the first region or a second size of the second region.

19. A non-transitory computer-readable storage medium having a computer program stored thereon, the computer program, when executed by a processor, implementing acts comprising:
receiving a processing request associated with media content;
obtaining, in response to the processing request indicating segmenting an object in the media content, a segmentation feature unit output by a model based on the media content and the processing request; and
generating a segmentation mask for the object based on the segmentation feature unit and a set of visual feature units associated with the media content.

20. The non-transitory computer-readable storage medium of claim 19, wherein the upsampling unit is trained based on a process of:
processing a set of training visual units by using the upsampling unit to generate a first visual feature corresponding to training media content;
determining, based on the first visual feature, a first segmentation feature of the training media content by using a pre-trained first segmentation model;
determining, based on the set of training visual units, a second segmentation feature of the training media content by using a pre-trained second segmentation model; and
training the upsampling unit based on a comparison between the first segmentation feature and the second segmentation feature.
